(19) United States
(12) Patent Application Publication
(10) Pub. No.: US 2011/0076124 A1
(43) Pub. Date: Mar. 31, 2011

(54) PICK-AND-PLACE APPARATUS

(75) Inventor: Tien-Te Yang, Keelung City (TW)

(73) Assignee: MJC PROBE INC., Hsinchu Hsiang (TW)

(21) Appl. No.: 12/616,530

(22) Filed: Nov. 11, 2009

(30) Foreign Application Priority Data
Sep. 29, 2009 (TW) 098132879

(51) Int. Cl. B65G 1/133

(52) U.S. Cl. 414/749.1

(57) ABSTRACT

An apparatus for performing pick-and-place operations is disclosed, which comprises: a power source; a transmission set, driven by the power source; a mobile seat, capable of being moved by the transmission set; and a retrieval head, coupled to the mobile seat; wherein the transmission set is configured with a driving shaft and a driven shaft as the two shafts are parallel-disposed while enabling the driving shaft to be driven by the power source; and the driving shaft has an active eccentric axle extruding from an end opposite to the power source, and the driven shaft has an passive eccentric axle extruding from an end opposite to the power source; and the active eccentric axle and the passive eccentric axle is coupled to the mobile seat for forming a four-bar linkage mechanism for maintaining the verticality and levelness of the mobile seat while being driven to move in an arc path.

### FIELD OF THE INVENTION

The present invention relates to an automatic transportation technology, and more particularly, to an apparatus for performing rapid pick-and-place operations with light objects in short distance.

### BACKGROUND OF THE INVENTION

During the manufacturing of electronic components or the assembling of electronic components, such electronic components will first be aligned and transported by feeders and then being picked up and moved sequentially by pick-and-place apparatuses to its corresponding working stations, such as an inspection device, a sorting device, etc., where they are released so as to be processed thereby. Generally, such pick-and-place apparatuses are only capable of performing rapid pick-and-place operations in short distance upon light-weighted electronic components, such as LED chips.

The aforesaid pick-and-place apparatus usually has a suction nozzle capable of moving vertically and horizontally in a reciprocating manner, in that the pick-and-place apparatus first moves its suction nozzle to the distribution location of a specified feeder for picking up electronic components, and then the pick-and-place apparatus brings the suction nozzle along with the fetched electronic components to move upward that is followed by a horizontal displacement so as to position the suction nozzle along with the fetched electronic components directly on top of a specified working station where the suction nozzle is lowered for releasing the fetched electronic components. After the releasing, the suction nozzle will be moved in verse to the aforesaid moving path for returning the suction nozzle back to its initial position so as to preparing the same for another pick-up operation.

There are already many pick-and-place apparatus being developed similar to the aforesaid apparatus. One of which is an apparatus for inspecting electronic components disclosed in TW Pub. No. 200535420. The aforesaid inspection apparatus is substantially a swing arm mounted on a rotary shaft capable of being driven to swing in a reciprocating manner by the use of a servo motor, in that swing arm further has a nozzle seat coupled to its fixed axis while the nozzle seat is being mounted on a vertical unit disposed on a horizontal-disposed linear rail.

Operationally, as soon as the rotary shaft is driven to rotate by the servo motor, the swing arm will be brought along to swing by the rotation of the rotary shaft and thus cause the nozzle seat to move following an arc path centering about the rotary axis of the swing arm since the nozzle seat is coupled to the fixed axis of the swinging swing arm. However, by the cooperation between the vertical unit and the horizontal-disposed linear rail, the nozzle seat along with the nozzle mounted thereon will be maintained in an upright position for allowing the nozzle to perform a picking-transporting-releasing operation.

It is noted that the aforesaid vertical unit is substantially a vertical guide rail and the horizontal-disposed linear rail is substantially a horizontal guide rail. Thereby, the nozzle seat and the nozzle mounted thereon can be maintain to stand upright by the defining of the vertical guide rail and the horizontal guide rail during the two are brought along to move with the swinging swing arm in the arc path. However, the defining of the vertical guide rail and the horizontal guide rail will certain interference and loss relating to the path of the movement that are going to cause certain limitations to the swinging of the swing arm when it is enabled to perform a high-speed reciprocating arc movement and thus it is impossible for the nozzle to finish each of its perform a picking-transporting-releasing operation in one reciprocating within 0.2 second.

Therefore, it is in need of a pick-and-place apparatus with improved performance for designing the same to operate in higher speed.

### SUMMARY OF THE INVENTION

In view of the disadvantages of prior art, the primary object of the present invention is to provide an apparatus for performing pick-and-place operations upon electronic components, in that while the active eccentric axle of its driving shaft and the passive eccentric axle of its driven shaft are simultaneously coupled to the mobile seat so as to formed a four-bar linkage mechanism capable of ensuring the verticality and levelness of the mobile seat to be maintained while being driven to move in an arc path and thus enhancing the operation speed of the pick-and-place apparatus as it can prevent the aforesaid path interference and loss from happening.

It is another object of the invention to provide a pick-and-place apparatus configured with a connecting mechanism at a position between the driving shaft and the driven shaft, by that the driving shaft and the driven shaft can be enabled to move in a synchronized manner and thus ensuring the verticality and levelness of the mobile seat to be maintained while being driven to move in an arc path.

It is further another object of the invention to provide a pick-and-place apparatus configured with a calibration part at a position between the base and the mobile seat in a detachable manner, which is composed of a number of long sides and short sides to be used respectively as the bumper bar of the mobile seat under a normal situation and as positioning means of the mobile seat during calibration, by that assembly convenience and the operation safety of the pick-and-place apparatus are enhanced.

To achieve the above object, the present invention provides an apparatus for performing pick-and-place operations upon electronic components, which comprises: a power source; a transmission set, driven by the power source; a mobile seat, capable of being brought along to move by the transmission set; and a retrieval head, coupled to the mobile seat; wherein the transmission set is configured with a driving shaft and a driven shaft in a manner that the two shafts are disposed parallel to each other while enabling the driving shaft to be driven by the power source; and the driving shaft has an active eccentric axle, being configured extruding from an end opposite to the power source, and the driven shaft has an passive eccentric axle, similarly being configured extruding from an end opposite to the power source, while enabling the active eccentric axle and the passive eccentric axle to be coupled to the mobile seat simultaneously.

Accordingly, when the driving shaft is enabled to rotate, it will drive the active eccentric axle to move and thus bring along the mobile seat to move as well. It is noted that since the active eccentric axle and the passive eccentric axle are coupled to the mobile seat, the driving shaft, the driven shaft, the active eccentric axle and the passive eccentric axle are interconnected with each other to form a four-bar linkage mechanism by that the verticality and levelness of the mobile seat can be maintained while being driven to move in an arc path as such four-bar linkage mechanism can prevent the aforesaid path interference and loss from happening and thus enhance the operation speed of the pick-and-place apparatus.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a three dimensional view of a pick-and-place apparatus of the invention.

FIG. 2 is an exploded view of a pick-and-place apparatus of the invention.

FIG. 3 is a schematic diagram showing a transmission set, a mobile seat and a shaft seat used in of a pick-and-place apparatus of the invention.

FIG. 4 is a schematic diagram showing how the mobile seat of the invention can be driven to move.

FIG. 5 is a schematic diagram showing a calibration part, a bottom plate and a mobile seat used in of a pick-and-place apparatus of the invention.

FIG. 6 is a schematic diagram showing an operating calibration part of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

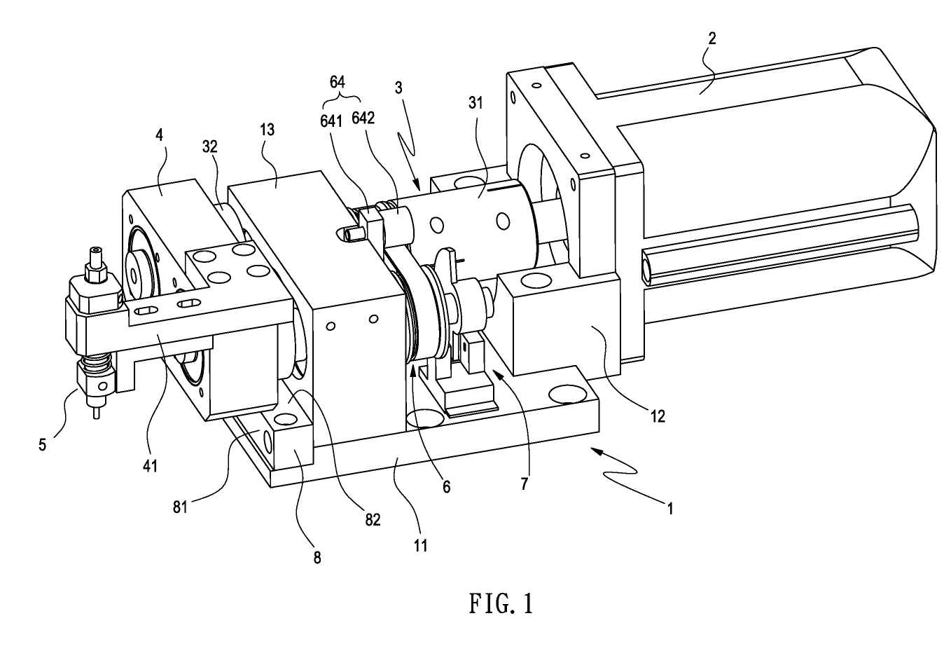

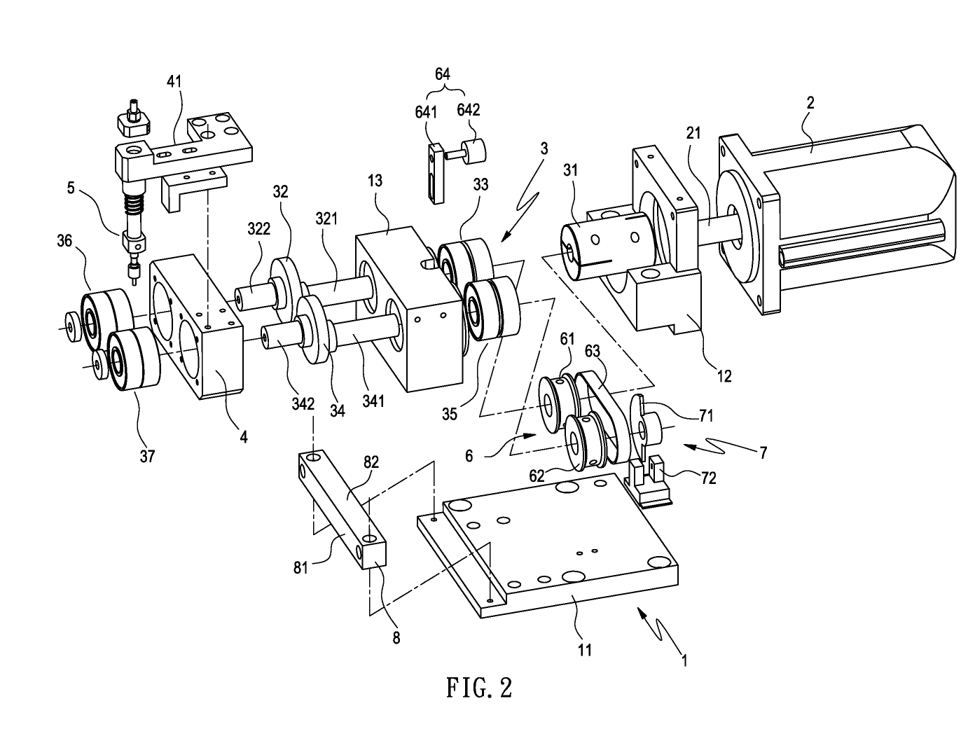

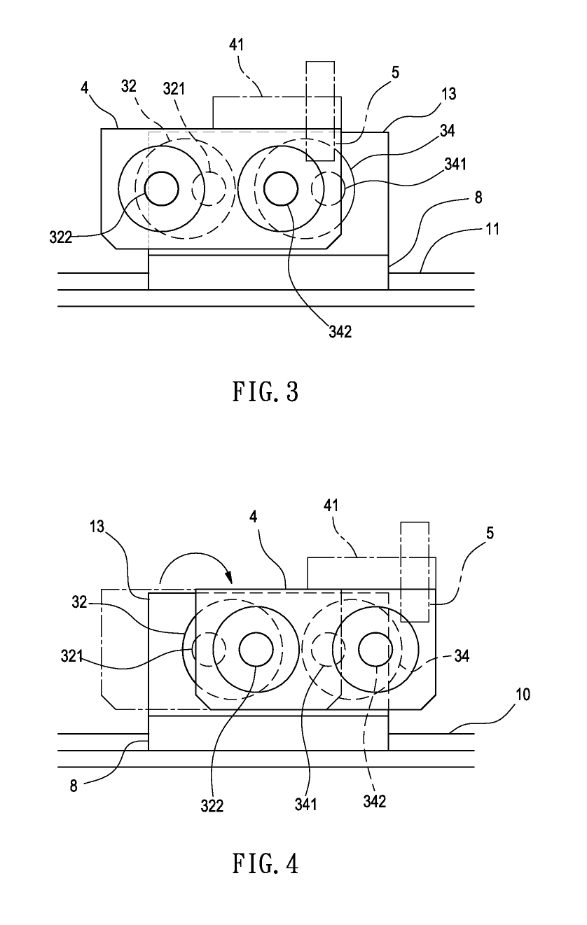

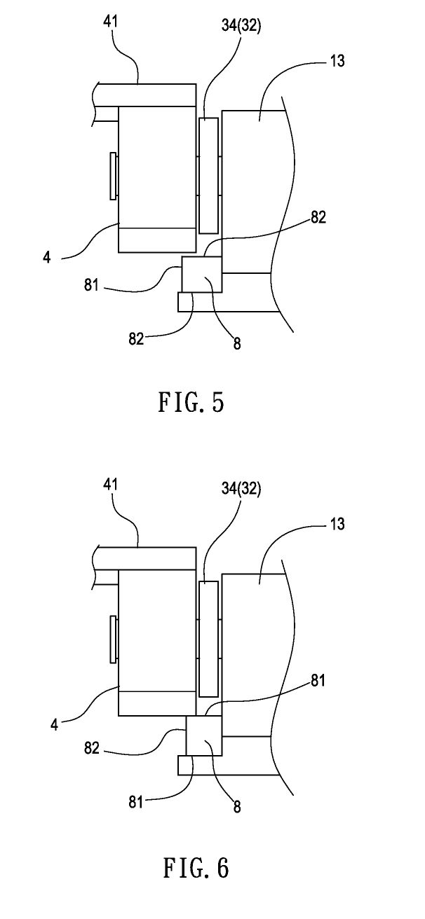

FIG. 1 is a three dimensional view of a pick-and-place apparatus of the invention. FIG. 2 is an exploded view of a pick-and-place apparatus of the invention. FIG. 3 is a schematic diagram showing a transmission set, a mobile seat and a shaft seat used in of a pick-and-place apparatus of the invention. FIG. 4 is a schematic diagram showing how the mobile seat of the invention can be driven to move. FIG. 5 is a schematic diagram showing a calibration part, a bottom plate and a mobile seat used in of a pick-and-place apparatus of the invention. FIG. 6 is a schematic diagram showing an operating calibration part of the invention.

As shown in FIG. 1, the pick-and-place apparatus of the invention has a power source, such as the servo motor 2, which is mounted on a base 1 to be used for driving a transmission set 3. In this embodiment, the transmission set 3 is designed to drive a mobile seat 4 for enabling the same to move following an arc path, and thereby, bringing along at least one retrieval head 5 on the mobile seat to move accordingly while enabling each retrieval head 5 to perform a picking-transporting-releasing operation upon a specific object such as electronic components.

The base 1 has a bottom panel 11, which is coupled to a motor seat 12 by a side thereof that is provided for the servo motor 2 to mounted thereon. In addition, there is an axle seat 13 coupled to another side of the bottom panel 11 opposite to that coupled to the motor seat 12 while enabling the transmission set 3 to be disposed at a position between the motor seat 12 and the axle seat 13.

Moreover, the transmission set 3 has a shaft coupling 31, which is connected to the shaft 21 of the servo motor 2 by an end thereof while enabling another end thereof to be connected to an active eccentric wheel 32 as there are a driving shaft 321 and an active eccentric axle 322 respectively extending from the two ends of the active eccentric wheel 32. It is noted that the driving shaft 321 is coupled to the axle seat 13 through a first bearing 33 while enabling an end of the driving shaft 321 that is pieced passing through the first bearing 33 to be coupled to the shaft coupling 31.

In this embodiment, there is a passive eccentric wheel 34 mounted on the axle seat 13 that is disposed parallel with the active eccentric wheel 32, and there are a driven shaft 341 and a passive eccentric axle 342 respectively extending from the two ends of the passive eccentric wheel 34. It is noted that the driven shaft 341 is coupled to the axle seat 13 through a second bearing 35, and the active eccentric axle 322 is coupled to the mobile seat 4 through a third bearing 36 while the passive eccentric axle 342 is coupled to the mobile seat 4 through a fourth bearing 37. Thereby, when the driving shaft 321 is being driven to rotate, the active eccentric wheel 32 along with the active eccentric axle 322 will be brought along to move for driving the mobile seat 4 to move accordingly, while at the same time, the passive eccentric wheel 34 and the driven shaft 341 as well as its passive eccentric axle 342 will be driven to move in a synchronized manner, by that the verticality and levelness of the mobile seat 4 can be maintained while being driven to move in an arc path.

In this embodiment, the active eccentric wheel 32 along with the driving shaft 321 and the active eccentric axle 322 extending therefrom are constructed as a rigid body, and similarly, the passive eccentric wheel 34 along with the driven shaft 341 and the passive eccentric axle 342 extending therefrom are also constructed as a rigid body, whereas the wheel-like structure is so-designed for achieving a more stable rotation.

For ensuring the active eccentric wheel 32 and the passive eccentric wheel 34 to rotate in a synchronized manner and the same time, preventing the two from being jammed by the unsynchronized rotation, the pick-and-place apparatus of the invention further has a connecting mechanism 6 being configured therein at a position between the active eccentric wheel 32 and the passive eccentric wheel 34. The connecting mechanism 6 comprise: a driving pulley 61, connected to the driving shaft 321 of the active eccentric wheel 32 by an end thereof closer to the shaft coupling 31; a driven pulley 62, connected to the driven shaft 342 of the passive eccentric wheel 34 while being disposed at a position corresponding to the driving pulley 61; and a belt 63, being disposed wounding around the drive pulley 61 and the driven pulley 62. It is noted that the driving pulley 61, the driven pulley 62 and the belt 63 can be assembled as a gear pulley set, but is not limited thereby.

In this embodiment, the connecting mechanism 6 further comprises: a tension adjusting element 64, which is configured with an adjustable rack 641 having a roller 642 pivotally arranged at the upper section of the same while being enabled to abut against the belt 63 for adjusting the tension thereof

For controlling the operation of the servo motor 2, the pick-and-place apparatus of the invention further comprises a sensing module 7, which is composed of: a sensor 71, disposed connecting with the end of the driven shaft 641 that is extruding from the driven pulley 62; and a detector 72, disposed at a position corresponding to the sensor 71 on the bottom panel 11, capable of being triggered intermittently by the sensor 71 during the rotation thereof and thus emitting signals for controlling the operation of the servo motor 2. In this embodiment, the sensor 71 is formed in a shape of a fan wheel, and the detector 72 is substantially an optoelectronic switch.

If the object to be fetched by the pick-and-place apparatus of the invention is LED chips, the retrieval head 5 is preferred to be formed as a suction nozzle, but is not limited thereby. It is noted that the retrieval head 5 is constructed according to the type of the object to be fetched. Moreover, the retrieval head 5 is disposed at an end of a swing arm 41 while enabling another end of the swing arm 41 to be fixedly secured to the mobile seat 4.

The pick-and-place apparatus of the invention further comprises a calibration part 8, which is disposed at a position corresponding to the mobile seat 4. In this embodiment, the calibration part 8 is a bar-like structure disposed on the bottom panel 11 in a detachable manner. The calibration part 8 is featuring with a rectangle-shaped cross section composed of two long sides 82 and two short sides 81, by which, under a normal situation, the mobile seat 4 is separated from contacting with the calibration part 8 as the calibration part 8 is disposed abutting against the base 11 by one long side 82 selected from the two long sides 82. As shown in FIG. 5, the length of each long side 82 is equal to a distance measured between the base 11 and the mobile seat 4 while the mobile seat 4 is located at its initial position or its terminal position; and the length of each short side 81 is slightly shorter than that of the long side 82.

AS the active eccentric wheel 32 and the passive eccentric wheel 34 are mounted on the axle seat 13 in parallel through the driving shaft 321 and the driven shaft 341 while enabling their active eccentric axle 322 and the passive eccentric axle 342 to be coupled to the mobile seat 4 in respective, the formation of the axle seat 13, the active eccentric wheel 32, the passive eccentric wheel 34 and the mobile seat 4 is constructed as a four-bar linkage mechanism, as shown in FIG. 3 and FIG. 4. It is known that a conventional four-bar linkage mechanism commonly seen in many machinery are generally composed of a fixing bar, a first bar, a second bar and a third bar that are interconnected with each other into a parallelogram with the fixing bar being arranged opposite to the second bar and the first bar being arranged opposite to the third bar. It is noted that the axle seat 13 is acting as the fixing bar; the mobile seat is acting as the second bar; the active eccentric wheel 32, especially the portion thereof extending from its driving shaft 321 to its active eccentric axle 322, is acting as the first bar; and the passive eccentric wheel 34, especially the portion thereof extending from its driven shaft 341 to its passive eccentric axle 342, is acting as the third bar.

During the period when the mobile seat is being driven to move following the arc path, its verticality and levelness are maintained as always so that the retrieval head 5 mounted at the front of the swing arm 41 that is fixed to the mobile seat 4 can maintain its upright position for allowing the same to perform picking-transporting-releasing operations upon objects to be fetched.

For improving the operation stability of the whole mechanism, it is preferred to arrange the performing of the picking motion and the placing motion of the retrieval head 5 respectively at the two dead points of the four-bar linkage mechanism. That is, the picking motion and the placing motion of the retrieval head 5 are enabled respectively to be performed at the two limit positions which can be specified when the driving shaft 321, the active eccentric axle 322, the driven shaft 341 and the passive eccentric axle 342 are aligned to a straight line, as shown in FIG. 3 and FIG. 4. Thereby, the operation stability of the pick-and-place apparatus of the invention is enhanced.

Operationally, the stroke of the pick-and-place apparatus of the invention measured between its picking motion and placing motion is about 15 mm in horizontal direction and 75 mm in vertical direction, which is not achievable through the direct application of any conventional four-bar linkage mechanism since it is hard to manufacture linkage bars and couplings that are smaller enough. Therefore, in the embodiment of the invention, the four part used as the four bar in the linkage mechanism, i.e. the driving shaft 321, the active eccentric axle 322, the driven shaft 341 and the passive eccentric axle 342, are respectively being arranged passing through the four bearings 33, 34, 35, 36 so as to achieve suitable couplings required. Accordingly, the sizes of those bearings are allowed to be larger than the distance measured on the active eccentric wheel 32 between the driving shaft 321 and the active eccentric axle 322, so that the parts used for forming the four-bar linkage mechanism suitable for the pick-and-place apparatus of the invention are not only can be manufactured easily, but also can be assembled easily.

Moreover, as the driving shaft 321 and the driven shaft 341 are pivotally coupled to the axle 13 and that is the same to the active eccentric wheel 32 and the passive eccentric wheel 34 relating to the mobile seat 4, there will be no such prior-art interference and loss relating to the path of the movement when the mobile seat 4 is being driven by the servo motor 2 to move in the arc path. Therefore, by the use of the pick-and-place apparatus of the invention, the operation speed relating to the picking-transporting-releasing operation is improved comparing with those conventional apparatus. Experimentally, the pick-and-place apparatus of the invention can perform a picking-transporting-releasing operation in one reciprocating within 0.15 second, which is about 25% improvement comparing with prior arts.

Moreover, by the arrangement of the connecting mechanism between the driving shaft 321 and the driven shaft 341, the driving shaft 321 and the driven shaft 341 can be enabled to rotate in synchronization, by that there will be no position difference between the active eccentric axle 322 and the passive eccentric axle 342 and thus the verticality and levelness of the mobile seat 4 can be ensured during the performing of the picking-transporting-releasing operations.

In addition, as the calibration part 8 is designed with a rectangle-shaped cross section composed of two long sides 82 and two short sides 81 and as the length of each long side 82 is designed to be equal to a distance measured between the bottom panel 11 and the mobile seat 4 while the mobile seat is located at its initial position or its terminal position, the calibration part 8 will abut against the bottom panel 11 by one short side 81 selected from the two short sides 81 when it is used for calibrating the positioning of the mobile seat 4, as shown in FIG. 6. That is, when the bottom of the mobile seat 4 engages with one short side 81 of the calibration part 8, the current positioning of the mobile seat 4 is defined to be its initial position or its terminal position. Thereby, the mobile seat 4 can be positioned precisely and conveniently during the assembling or maintenance.

However, under normal situation, the calibration part 8 is enabled to abut against the bottom panel 11 by one long side 82 selected from the two long sides 82 so as to separate the mobile seat 4 from contacting with the calibration part 8.

Moreover, since the length of the short side 81 is slightly shorter than that of the long side 82, the short sides 81 can be used as the bumper bars of the mobile seat 4 under the normal situation. Accordingly, when the mobile seat is accidentally moving outside the designed path, its movement will be obstructed by the calibration part 8 and thus prevent any devices that are mounted on the mobile seat 4 from colliding with its surrounding equipments.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A pick-and-place apparatus, comprising:
a power source;
a transmission set, composed of a driving shaft and a driven shaft while enabling the driving shaft to be driven by the power source;
a mobile seat, mounted on the driving shaft and the driven shaft; and
a retrieval head, coupled to the mobile seat;
wherein, the driving shaft and the driven shaft are disposed parallel to each other while configuring the driving shaft with an active eccentric axle in a manner that it is extruding from an end thereof opposite to the power source, and configuring the driven shaft with an passive eccentric axle in a manner that it is extruding from an end thereof opposite to the power source.

2. The pick-and-place apparatus of claim 1, further comprising:
an axle seat, provided for the driving shaft and the driven shaft to be arranged thereat in respective.

3. The pick-and-place apparatus of claim 2, wherein the driving shaft is coupled to the axle seat through a first bearing while the driven shaft is coupled to the axle seat through a second bearing.

4. The pick-and-place apparatus of claim 2, further comprising:
a base, provided for the power source to be arranged thereat and the axle seat to be fixed thereto.

5. The pick-and-place apparatus of claim 4, further comprising:
a calibration part, disposed at a position between the base and the mobile seat in a detachable manner while enabling the mobile seat to be separated from contacting with the calibration part under a normal situation and enabling the mobile seat to engage with the calibration part for performing a calibration operation.

6. The pick-and-place apparatus of claim 5, wherein the calibration part is a bar-like structure with a rectangle-shaped cross section composed of two long sides and two shorts sides while enabling the calibration part to abut against the base by one long side selected from the two long sides under the normal situation; and the length of each long side is equal to a distance measured between the base and the mobile seat while the mobile seat is located at its initial position or its terminal position; and the length of each short side is slightly shorter than that of the long side.

7. The pick-and-place apparatus of claim 1, wherein the transmission set further comprises:
a shaft coupling, disposed for enabling an end thereof to be connected to the power source while connecting another end thereof to the driving shaft.

8. The pick-and-place apparatus of claim 1, wherein the active eccentric axle is coupled to the mobile seat through a third bearing while the passive eccentric axle is coupled to the mobile seat through a fourth bearing.

9. The pick-and-place apparatus of claim 1, wherein there is a connecting mechanism arranged between the driving shaft and the driven shaft to be used for enabling the driving shaft and the driven shaft to move in a synchronized manner.

10. The pick-and-place apparatus of claim 9, wherein the connecting mechanism further comprises:
a driving pulley, connected to the driving shaft by an end thereof closer to the shaft coupling;
a driven pulley, connected to the driven shaft while being disposed at a position corresponding to the driving pulley; and
a belt, wound around the drive pulley and the driven pulley.

11. The pick-and-place apparatus of claim 10, wherein the driving pulley, the driven pulley and the belt are assembled into a gear pulley set.

12. The pick-and-place apparatus of claim 10, wherein the connecting mechanism further comprises:
a tension adjusting element, further configured with an adjustable rack having a roller pivotally arranged at the upper section of the same while being enabled to abut against the belt for adjusting the tension thereof.

13. The pick-and-place apparatus of claim 1, further comprising:
a sensing module, comprising:
a sensor, connected to the driven shaft; and
a detector, disposed at a position corresponding to the sensor, capable of being triggered intermittently by the sensor during the rotation thereof and thus emitting signals for controlling the operation of the power source.

14. The pick-and-place apparatus of claim 13, wherein the sensor is formed in a shape of a fan wheel, and the detector is substantially an optoelectronic switch.

15. The pick-and-place apparatus of claim 1, wherein the retrieval head is substantially a vacuum suction nozzle.

16. The pick-and-place apparatus of claim 1, wherein the retrieval head is disposed at the front end of a swing arm while enabling another end of the swing arm to be fixedly connected to the mobile seat.
